(19) United States
(12) Patent Application Publication
(10) Pub. No.: US 2002/0086270 A1
(43) Pub. Date: Jul. 4, 2002

(54) Method of teaching vocabulary

(76) Inventor: Renee Mazer, Berwyn, PA (US)

Correspondence Address: Renee Mazer, 1014 Signal Hill Road, Berwyn, PA, 19312, US

(21) Appl. No.: 10/053,950

(22) Filed: Nov. 16, 2001

Related U.S. Application Data
(60) Provisional application No. 60/252,138, filed on Nov. 17, 2000.

(51) Int. Cl. G09B 19/00

(52) U.S. Cl. 434/156

(57) ABSTRACT

The present invention provides methods of teaching vocabulary words using music and/or poetry recorded on media such as audio cassettes, video cassettes, CDs, computer readable media, and the like. The invention may be in the form of a poem, song, lyrics, and the like. The many uses of the present invention include improving a student's performance on standardized examinations.

### CROSS REFERENCE TO RELATED APPLICATION

This application claims priority to, and the benefit of, U.S. Provisional Application Serial No. 60/252,138, filed Nov. 17, 2000.

### FIELD OF THE INVENTION

The present invention relates generally to the field of teaching vocabulary to students in need of same. More particularly, the invention relates to novel methods of improving performance on standardized examinations by teaching vocabulary through the use of music and/or poetry.

### BACKGROUND

Standardized examinations present a hurdle for students seeking to enter colleges, universities, and other advanced educational institutions. Such examinations include the Scholastic Aptitude Test (SAT), Graduate Record Exam (GRE), Secondary School Admissions Test (SSAT), Preliminary Scholastic Aptitude Test (PSAT), Miller Analogies Test (MAT), and the like. Since these and other examinations have portions devoted to testing the student's knowledge of vocabulary, many students' scores on such examinations may be improved by providing such students with improved vocabulary.

Current methods of teaching vocabulary words are fraught with problems. The mere provision of a list of vocabulary words and their meanings results in, at best, short term memory of the words, but little transfer to long term memory and therefore little retention. See, e.g., Atkins et al., Introduction to Psychology, (10^{th} ed., Harcourt, Brace Jovanovich College Publishers (1990) (simple rehearsal is not an effective means for transferring information to long term memory). Such methods also require a relatively large investment of time even to accomplish short term retention of the words. Therefore, the art is in need of improved methods of teaching vocabulary that results in long term memory and retention of the words, and thereby improved scores on standardized examinations.

### SUMMARY OF THE INVENTION

A more efficient means to achieving long term memory and improved retention is the provision of a narrative containing the information sought to be memorized. See, e.g., Crooks and Stein, Psychology, Science, Behavior and Life, (2^{nd} ed., Holt, Reinhart and Winston, Inc., pp. 239-40 (1991). The present invention relies on this principle that long term memory and retention is vastly improved if memorable imagery can be associated with the word being learned. Such imagery may be narrative in nature, and may be in auditory or visual form. The present invention provides poems, songs, and/or lyrics which teach the meaning of a word by use of the word in an appropriate context, while at the same time the phrasing, the melody, and/or the cadence of the poem, song, or lyrics provides imagery useful in transferring the learned word into long term memory.

The present invention also solves the problem of time commitment by allowing the student to listen to the teaching material virtually anywhere on a portable audio media player, and during a variety of activities; e.g., while driving in a car or taking a walk.

The present invention contemplates songs, poems, or lyrics, either with or without accompanying music. The poems, songs, or lyrics may be recorded to any medium, analog or digital, including but not limited to cassette tapes, compact discs, software media (e.g., MP3 files), and the like. The poems, songs, or lyrics may optionally include video accompaniment.

In one aspect of the invention, then, there is provided a method for teaching vocabulary comprising the steps of composing poems, songs, and/or lyrics which provides the meaning of the vocabulary word in an appropriate context, recording the poem, song, and/or lyrics on a medium, and providing the medium to a student. In another aspect, the present invention comprises the poem, song, or lyrics composed for practicing the method of the invention as described above and below. In another aspect, the present invention provides the poem, song, and/or lyrics recorded and fixed on a tangible medium. In another aspect, the present invention provides a kit comprising the tangible medium having the poem, song, and/or lyrics recorded thereon, and additional materials such as instruction booklets. In yet another aspect, the tangible medium on which the poem, song, and/or lyrics are recorded is a computer-usable medium. In another aspect, the computer-usable form of the poem, song, and/or lyrics are combined with video material, such as illustrations, animations, or video clips, to further aid in teaching of vocabulary words. In another aspect, the present invention provides the poem, song, and/or lyrics recorded on an audio medium.

Additional features and variations of the invention will be apparent to those skilled in the art from the entirety of this application, including the detailed description, and all such features are intended as aspects of the invention. Likewise, features of the invention described herein can be re-combined into additional embodiments that also are intended as aspects of the invention, irrespective of whether the combination of features is specifically mentioned above as an aspect or embodiment of the invention. Also, only such limitations which are described herein as critical to the invention should be viewed as such; variations of the invention lacking limitations which have not been described herein as critical are intended as aspects of the invention.

### DETAILED DESCRIPTION OF THE INVENTION

A more efficient means to achieving long term memory and improved retention is the provision of a narrative containing the information sought to be memorized. The present invention relies on this principle that long term memory and retention is vastly improved if memorable imagery can be associated with the word being learned.

Various definitions are made throughout this document. Most words have the meaning that would be attributed to those words by one skilled in the art. Words specifically defined either below or elsewhere in this document have the meaning provided in the context of the present invention as a whole and as are typically understood by those skilled in the art.

As used herein, the word “student” means any person in need of improved vocabulary. Student is intended to include not only school students preparing for standardized examinations, but any person to whom vocabulary is to be taught.

As used herein, the phrase “medium” or “media” means any form of media which contains audio information, whether analog or digital, and includes, but is not limited to records (“LPs”), cassette tapes (analog or digital), compact discs (“CDs”), video tapes, laser discs, digital video discs (“DVDs”), computer-usable media (such as computer files, e.g., MP3 files), and the like. The term “computer-usable” medium is intended to encompass all forms of media which are readable by a computer and which may store audio information, e.g., CDROM, CDR, CDRW, floppy disks, ZIP disks, hard drives, and the like, as well as downloadable files which are stored on such media. In addition to audio information, media may optionally comprise complementary video information.

As used herein, “complementary video information” means video material designed to assist in the teaching of a vocabulary word. Such video material may be in the form of a video of the performance of the poem, song, or lyrics, or may comprise visual text, illustrations, animation, video clips, or other graphic material.

As used herein, the phrase “providing the medium” when used in reference to delivery of the recorded poem, song, or lyrics to a student means transferring physical possession of the medium to the student, whether directly or via an intermediary, or providing access to the medium via a computer network such as the Internet.

In one embodiment, the invention provides a method for teaching vocabulary comprising the steps of composing a poem, song, or lyrics which provides the meaning of the vocabulary word in an appropriate context, recording the poem, song, or lyrics on a medium, and providing the poem, song, or lyrics on the medium to a student. In another embodiment, the present invention comprises the poem, song, or lyrics composed for practicing the method of the invention stored on an audio medium as described herein.

In a preferred embodiment of the present invention, the medium on which the poem, song, or lyrics are recorded is an audio cassette. In another preferred embodiment of the present invention, the medium on which the poem, song, or lyrics are recorded is a video cassette, which has recorded upon it both audio and video information. In another preferred embodiment of the present invention, the medium on which the poem, song, or lyrics are recorded is a computer-usable medium.

In an embodiment wherein the medium is a computer-usable medium, the computer-usable form of the poem, song, or lyrics are combined with complementary video material, such as illustrations, animations, or video clips, to further aid in teaching of vocabulary words.

For each of the previously described embodiments of the present invention, it is preferred to provide a kit comprising the medium having the poem, song, or lyrics recorded thereon, and additional materials such as instruction booklets.

Some of the preferred embodiments of the invention described above are outlined below and include, but are not limited to, the following Examples. As those skilled in the art will appreciate, numerous changes and modifications may be made to the preferred embodiments of the invention without departing from the spirit of the invention. It is intended that all such variations fall within the scope of the invention.

The entire disclosure of each publication, document, or other reference cited herein is hereby incorporated by reference.

### EXAMPLE 1

### Teaching of the Word “Contrite”

The word “contrite” is defined as “grieving and penitent for sin or shortcoming.” (Webster's Ninth New Collegiate Dictionary, Merriam-Webster, Inc., 1990). A song was composed in order to use the word “contrite” in context such as to not only provide a student with the definition, but also to assist in transferring the meaning of the word into the student's long-term memory. The lyrics of the song are as follows:

When he stole his sister's Barbie he was contrite.

Deep down in his heart he knew it just wasn't right.

But the doll was so cute

and no one can refute

that if held bought it at the store

he'd be teased 'til he couldn't take it anymore.

The song was sung to a melody and recorded on an audio cassette. The cassette is provided to a student in need of learning vocabulary words, with or without additional example words, or may be packaged and sold to such a student with or without additional materials, such as instruction booklets.

### EXAMPLE 2

### Teaching of Several Words in a Single Poem

A poem was composed in order to use several words in context such as to not only provide a student with the definition of such words, but also to assist in transferring the meaning of the words into the student's long-term memory. The lyrics of the poem are as follows:

I called up Great Expectations

cause with men I wanted relations.

I told them please send me some studs

but they misheard me and sent me their duds.

There was portly Peter who had a huge girth

and never stopped talking about his net worth.

Shiftless Sean had no job.

Imperious Ian was an arrogant snob.

Sinister Sam was creepy and mean.

Fastidious Farrell was obsessed with keeping his apartment clean.

Doleful Dan kept talking about his ex wife

and how she maliciously messed up his life.

Insipid Iggy put me to sleep he was so soporific

and with his ugly flood pants he dressed horriffic.

Cantankerous Carl was a misanthrope

with people he just didn't want to cope.

So I guess I'm going to go it alone

because apparently to losers I am prone.

The poem is recited and recorded on an audio cassette. The cassette is provided to a student in need of learning vocabulary words, with or without additional example words, or may be packaged and sold to such a student with or without additional materials, such as instruction booklets.

A poem was composed in order to use several words in context such as to not only provide a student with the definition of such words, but also to assist in transferring the meaning of the words into the student's long-term memory. The lyrics of the poem are as follows:

This morning I had a grey hair scare

while I was blow drying my hair.

This getting old stuff just isn't fair.

I plucked the hair out of my head

and to my son I said

“Come here. We have an exigent situation, get out of bed!”

He came running in and I showed him the hair.

I asked him if it was brown or grey.

He looked apathetic as if he just didn't care.

We came to a joint decision,

it was definitely not white

and while old age may be imminent, for now I look all right.

The poem is recited and recorded on an audio cassette. The cassette is provided to a student in need of learning vocabulary words, with or without additional example words, or may be packaged and sold to such a student with or without additional materials, such as instruction booklets.

### EXAMPLE 3

A song is composed to illustrate and teach the meaning of a word or several words. The song is sung with or without musical accompaniment and recorded on videotape. Several such songs may be included on the videotape. The videotape is packaged with an instruction booklet and distributed via retail establishments.

Alternatively, the composition teaching the word(s) is a poem or a narrative story, with or without musical accompaniment. The composition may optionally be accompanied by additional visual material. The recording medium may alternatively be any of the media described above.

I claim:

1. A method for teaching a vocabulary word comprising the steps of:
(a) composing a poem, song, or lyrics which provide the meaning of the vocabulary word in an appropriate context;
(b) recording the poem, song, or lyrics on a medium; and
(c) providing the medium to a student.

2. The method of claim 1, wherein the medium is a member selected from the group consisting of an LP, an audio cassette tape, a CD, a video tape, a laser disc, a DVD, and a computer-usable media.

3. The method of claim 2, wherein the medium is an audio cassette tape.

4. The method of claim 2, wherein the medium is a CD.

5. The method of claim 2, wherein the medium is a computer usable medium selected from the group consisting of a CDROM, a CDR, a CDRW, a floppy disk, a ZIP disk, and a hard drive.

6. The method of claim 5, wherein the medium is provided to the student via a computer network.

7. The method of any of claims 1-5, wherein the medium comprises complementary video information.

8. A poem, song, or lyrics stored on a medium, composed for teaching a vocabulary word to a student.

9. The poem, song, or lyrics of claim 8, wherein the medium is a member selected from the group consisting of an LP, an audio cassette tape, a CD, a video tape, a laser disc, a DVD, and a computer-usable media.

10. The poem, song, or lyrics of claim 9, wherein the medium is an audio cassette tape.

11. The poem, song, or lyrics of claim 9, wherein the medium is a CD.

12. The poem, song, or lyrics of claim 9, wherein the medium is a computer usable medium selected from the group consisting of a CDROM, a CDR, a CDRW, a floppy disk, a ZIP disk, and a hard drive.

13. The poem, song, or lyrics of claim 9, wherein the medium is provided to the student via a computer network.

14. The poem, song, or lyrics of any of claims 9-13, wherein the medium comprises complementary video information.

15. A kit comprising the medium comprising the song, story, or poem of any of claims 9-13 and instructions.
